(19) United States
(12) Patent Application Publication
(10) Pub. No.: US 2005/0069297 A1
(43) Pub. Date: Mar. 31, 2005

(54) Video signal processing apparatus video signal processing method program and recording medium

(76) Inventors: Masaaki Kobayashi, Hyogo (JP); Toyohiko Matsuta, Osaka (JP); Masaaki Nakayama, Osaka (JP); Mitsuru Yasukata, Osaka (JP)

Correspondence Address: RATNERPRESTIA, P O BOX 980, VALLEY FORGE, PA, 19482-0980, US

(21) Appl. No.: 10/493,770

(22) PCT Filed: Oct. 24, 2002
(86) PCT No.: PCT/JP02/11037

(30) Foreign Application Priority Data
Oct. 25, 2001 (JP) 2001-327341

(51) Int. Cl. H04N 5/76; H04N 5/225

(52) U.S. Cl. 386/120; 348/220.1

(57) ABSTRACT

A first moving image information volume compression encoder which compression-encodes a video signal from a camera part as a moving image, a second still image information volume compression encoder which compression-encodes the input video signal as a still image, and recording means which records, in memory means, both a first compression signal obtained by the first compression encoder and a second compression signal obtained by the second compression encoder. The compression encoders shoot based on shutters respectively which are independent of each other.

### TECHNICAL FIELD

The present invention relates to a video signal processing apparatus, a video signal processing method, a program and a recording medium, all of which are for recording video signals as plural types of compression signals.

### BACKGROUND ART

The recent years have seen proliferation of apparatuses and machines which process a video signal through high efficiency coding processing (so-called compression coding processing) and record or transmit the signal. Video signals handled by these vary in terms of type representing whether an image is a still image or a moving image, and in terms of a number of pixel, a number of frame etc., and therefore, a variety of compression methods such as MPEG2, MPEG4 and JPEG have been proposed or actually used (See Japanese Patent Application Laid-Open Gazette No. 2001-86510 for example.).

Meanwhile, in addition to conventional magnetic tapes, a variety of record media such as optical disks, magneto-optic disks, hard disks and semiconductor memories have started to be used.

However, an apparatus for recording and reproducing a video signal, for example, for a movie, which uses a magnetic tape, a semiconductor memory, a small-diameter disk or the like, owing to the structure of the apparatus, finds it difficult to shoot a still image of a particular scene in response to a cameraman's wish while shooting a moving image, that is, to record both a moving image and a still image in accordance with an instruction from a cameraman.

In the meantime, according to the invention described in Japanese Patent Application Laid-Open Gazette No. 2001-86510, a recording rate is determined in accordance with a shooting mode which was selected before shooting.

There still is a problem however that although such an apparatus allows to determine an image quality in line with a cameraman's wish, it is not possible to shoot or store a particular scene as a high-quality still image in response to a cameraman's wish while shooting a moving image.

### SUMMARY OF THE INVENTION

Considering the problem with the conventional apparatus described above, the present invention aims at providing a video signal processing apparatus, a video signal processing method, a program and a recording medium with which it is possible to shoot a still image of a particular scene in response to a cameraman's wish while shooting a moving image.

A first invention of the present invention is a video signal processing apparatus, comprising:
first compression encoder means (ex. reference symbol 2 in FIG. 4) of compression-encoding an input video signal as a moving image;
second compression encoder means (ex. reference symbol 4) of compression-encoding said input video signal as a still image; and
recording means (ex. reference symbol 3) of recording both a first compression signal obtained by said first compression encoder means and a second compression signal obtained by said second compression encoder means,
wherein said first compression encoder means and said second compression encoder means can be controlled independently of each other.

A second invention of the present invention is the video signal processing apparatus according to the first invention of the present invention, wherein said recording means also records additional information which associates said first compression signal to said second compression signal based on a predetermined reference.

A third invention of the present invention is the video signal processing apparatus according to the second invention of the present invention, comprising:
reproducing means (ex. reference symbol 7) of reproducing said recorded signals;
first expansion decoder means (ex. reference symbol 8) of expanding said first compression signal among said reproduced signals and outputs as a first expansion signal;
second expansion decoder means (ex. reference symbol 10) of expanding said second compression signal among said reproduced signals and outputs as a second expansion signal; and
synthesizing and outputting means (ex. reference symbol 21) of synthesizing said first expansion signal and said second expansion signal with each other and outputs the synthesized signal on a same screen.

A fourth invention of the present invention is the video signal processing apparatus according to the third invention of the present invention, wherein said second compression signal which is to be reproduced is selected or the timing of outputting said second compression signal is determined, based on said additional information.

A fifth invention of the present invention is the video signal processing apparatus according to the fourth invention of the present invention, wherein said additional information is associations referring to a shooting time and added at least to said second compression signal, and
said reproducing means specifies said second compression signal which is to be reproduced based on time stamp information contained in said first compression signal and said additional information added to said second compression signal, and determines timing of starting reproduction of said second compression signal.

A sixth invention of the present invention is the video signal processing apparatus according to the fifth invention of the present invention, wherein the timing of starting reproduction is determined so as to be substantially the same as the timing (ex. a time corresponding to reference symbol t0 in FIG. 2) at which said first compression signal (ex. reference symbol S1 in FIG. 2) decoded by said first expansion decoder means (reference symbol 8) starts being displayed by display means (reference symbol 11), and
a timing of a start of displaying of a second compression signal (ex. reference symbol S22) which is shot at the shooting time (ex. reference symbol t2) following a shooing time of a second compression signal (ex. reference symbol S21) which has started to be displayed substantially coincides with the timing which corresponds to a shooting time (ex. reference symbol t1) of a second compression signal (ex. reference symbol S21) which has been displayed until just before the timing of the start of displaying of the second compression signal.

A seventh invention of the present invention is a video signal processing method, comprising:
a first compression encoding step of compression-encoding an input video signal as a moving image;
a second compression encoding step of compression-encoding said input video signal as a still image; and
a recording step of recording both a first compression signal obtained at said first compression encoding step and a second compression signal obtained at said second compression encoding step,
wherein an operation of said first compression encoder means and an operation of said second compression encoder means can be controlled independently of each other.

An eighth invention of the present invention is a program which operates in co-operation with a computer and which makes the computer function as (a) first compression encoder means of compression-encoding an input video signal as a moving image, (b) second compression encoder means of compression-encoding said input video signal as a still image, and (c) recording means of recording both a first compression signal obtained by said first compression encoder means and a second compression signal obtained by said second compression encoder means of the video signal processing apparatus according to any one of the first to the sixth inventions of the present invention.

A ninth invention of the present invention is a program which makes a computer execute (a) a first compression encoding step of compression-encoding an input video signal as a moving image, (b) a second compression encoding step of compression-encoding said input video signal as a still image, and (c) a recording step of recording both a first compression signal obtained at said first compression encoding step and a second compression signal obtained at said second compression encoding step of the video signal processing method according to the seventh invention of the present invention.

A tenth invention of the present invention is a recording medium which can be processed by a computer and which holds the program according to the eighth or the ninth invention of the present invention.

Hence, even during recording of an input video signal as a moving image for instance, it is possible to shoot and record a high-quality still image at any desired timing in accordance with a cameraman's wish.

### BRIEF DESCRIPTION OF THE DRAWINGS

FIG. 1 is a block diagram which shows a structure of a video signal recording and reproducing apparatus according to a first embodiment of the present invention;

FIG. 2 is a conceptual drawing of a record signal string for describing an operation of the video signal recording and reproducing apparatus according to the first embodiment;

FIG. 3 is a block diagram which shows other structure of the video signal recording and reproducing apparatus according to the first embodiment;

FIG. 4 is a block diagram which shows a structure of a video signal recording and reproducing apparatus according to a second embodiment of the present invention;

FIG. 5 is a conceptual drawing which shows a monitor screen which expresses an output signal from the video signal recording and reproducing apparatus according to the second embodiment;

FIG. 6 is a flow chart for describing an operation of the video signal recording and reproducing apparatus according to the second embodiment; and

FIG. 7 is a block diagram which shows another structure of the video signal recording and reproducing apparatus according to the second embodiment.

### EXPLANATION OF REFERENCE SYMBOLS

1 camera part
2 moving image information volume compression encoder
3 recording means
4 still image information volume compression encoder
5 bus
6 memory means
7 reproducing means
8 moving image information volume expansion encoder
9 switch
10 still image information volume expansion decoder
11 monitor TV
12 moving image shooting shutter
13 still image shooting shutter
14 moving image/still image switch signal
21 picture-in-picture circuit (PinP circuit)

### BEST MODE FOR IMPLEMENTING THE INVENTION

With reference to the associated drawings, embodiments of the present invention will now be described.

### FIRST EMBODIMENT

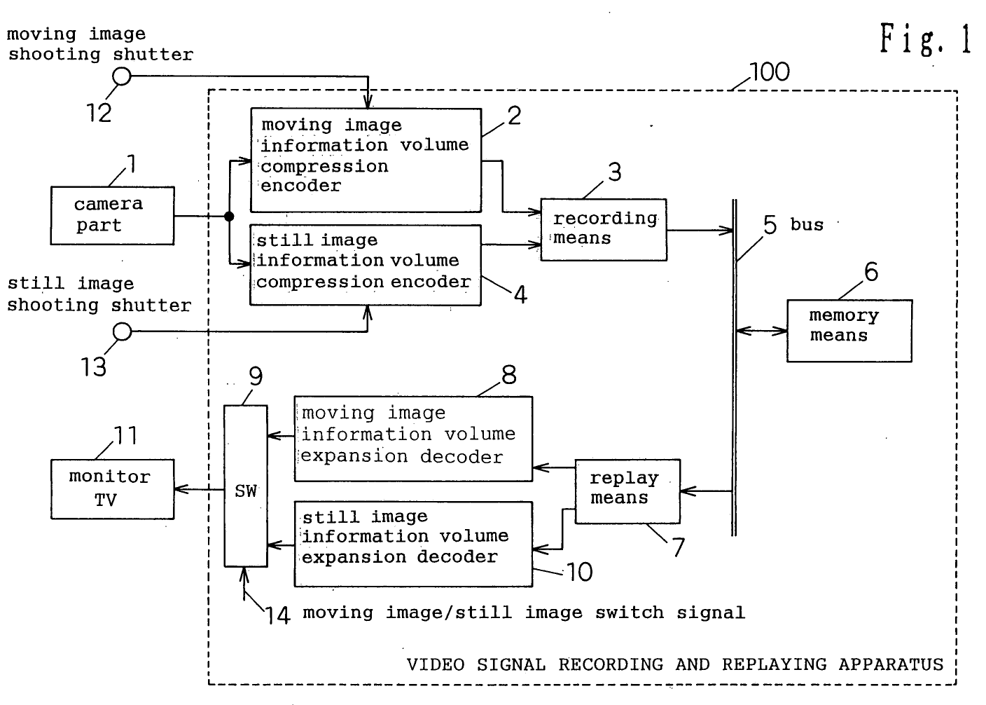

FIG. 1 is a block diagram which shows a structure of a video signal recording and reproducing apparatus according to a first embodiment of the present invention.

In FIG. 1, denoted at 1 is a camera part and denoted at 2 is a moving image information volume compression encoder. Denoted at 3 is recording means and denoted at 4 is a still image information volume compression encoder. Denoted at 5 is an internal bus and denoted at 6 is memory means formed by a memory card and so on which can be attached and detached. Denoted at 7 is reproducing means and denoted at 8 is a moving image information volume expansion decoder.

Denoted at 9 is a switch (SW) and denoted at 10 is a still image information volume expansion decoder. Denoted at 11 is a monitor TV. Denoted at 12 is a moving image shooting shutter and denoted at 13 is a still image shooting shutter. Denoted at 14 is a moving image/still image switch signal.

A video signal recording and reproducing apparatus 100 consists of the moving image information volume compression encoder 2, the recording means 3, the still image information volume compression encoder 4, the bus 5, the memory means 6, the reproducing means 7, the moving image information volume expansion decoder 8, the still image information volume expansion encoder 10, the switch 9, the moving image shooting shutter 12 and the still image shooting shutter 13.

A video signal shot with the Camera part 1 is fed to the video signal recording and reproducing apparatus 100. An output signal from the video signal recording and reproducing apparatus 100 is fed to the monitor TV 11.

The recording means 3 and the reproducing means 7 record/reproduce a compressed data file into/from the memory means 8 based on a FAT (File Allocation Table).

First compression encoder means of the present invention corresponds to the moving image information volume compression encoder 2. Meanwhile, second compression encoder means of the present invention corresponds to the still image information volume compression encoder 4.

First expansion decoder means of the present invention corresponds to the moving image information volume expansion decoder 8. Second expansion decoder means of the present invention corresponds to the still image information volume expansion decoder 10.

When the moving image information volume compression encoder 2 is an information volume compression encoder using MPEG4, while the moving image shooting shutter 14 stays open, a video signal obtained through the camera part 1 is converted into a 256-kbps compression signal by the moving image information volume compression encoder 2. The recording means 3 adds additional information needed for recording to the compression signal, and the compression signal is converted into a record signal string S1 which is suitable to the memory means 6 which serves as a recording medium, and recorded in a file format for example in the memory means 6 via the bus 5.

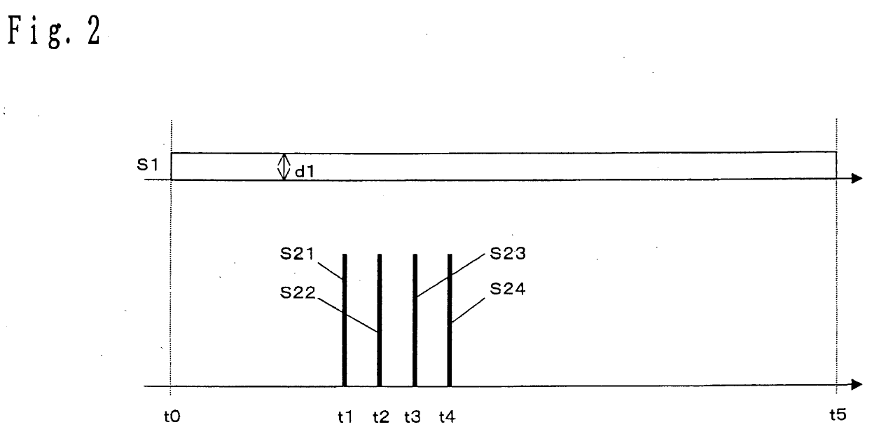

As shown in FIG. 2, when a period of time (from t0 to t5) during which the moving image shooting shutter 12 remains open is one hour and a bit rate d1 for the record signal string S1 is 278 kbps for instance (based on an assumption that the additional information has led to an increase by about 10%), 125-MB data are recorded in the memory means 6.

On the other hand, the video signal obtained through the camera part 1 is given also to the still image information volume compression encoder 4. When the still image information volume compression encoder 4 is an information volume compression encoder using JPEG, of video signals obtained through the camera part 1, only a still image which depicts a scene taken as the still image shooting shutter 13 was pressed is converted into a high-quality still image compression signal having 1 MB for example by the still image information volume compression encoder 4.

When a time of the scene taken as the still image shooting shutter 13 was pressed is t1, the recording means 3 adds additional information (the assumption again is that this amounts to +10%) to the compression signal, and the compression signal is recorded in the memory means 6 as a record signal string S21 (file) whose data volume is 1.1 MB.

When the still image shooting shutter 13 is pressed at the time t2, t3 and t4, record signal strings S22, S23 and S24 each having a data volume of 1.1 MB are recorded in the memory means 6. In total, 129.4 MB of data (125 MB+4×1.1 MB) are recorded in the memory means 6.

The still image shooting shutter 13 is disposed independently of the moving image shooting shutter 12, and is capable of shooting a still image regardless of an operation of the moving image shooting shutter 12.

When the memory means 6 is formed by a 256-MB flash memory, these pieces of data are recorded leaving enough room.

As for the memory means 6, an input/output bit rate of 2 Mbps through 10 Mbps has been already achieved, and therefore, even if the bit rate temporarily hikes for instance, it is possible to perform recording and reproducing without any problem.

In general, such a structure realizes recording of a high-quality still image representing a scene which requires a high image quality, during recording of a moving image which lasts for about scores of minutes to about two hours.

During reproduction, data read from the memory means 6 are restored into the MPEG4 data string S1 and the JPEG data strings S21, S22, S23 and S24 by the reproducing means 7 via the bus 5.

Of these data strings, S1 is restored back into a video signal which represents the original 1-hour moving image signal by the moving image information volume expansion decoder 8 which is formed by an MPEG4 decoder for example. Of these data strings, S21 through S24 are restored back into video signals which represent the original four still images by the still image information volume expansion decoder 10 which is formed by a JPEG decoder for instance.

The video signal thus restored is switched by the switch 9 as instructed by the moving image/still image switch signal 14, and appears on the monitor TV 11.

The moving image/still image switch signal 14 may be generated based on an external switch of the video signal recording and reproducing apparatus 100 or by internal control means (not shown). In the event that the signal is generated based on internal control means, a content recorded in the memory means 6 is configured in advance so that it will be possible to designate, and automatically switched depending on the type of designated data.

Additional information which associates a moving image file with a still image file may be added to the both or either one in the recording means 3. Further, a time at which a still image was generated may be made common to a time stamp, a presentation time or the like to be recorded in a moving image file.

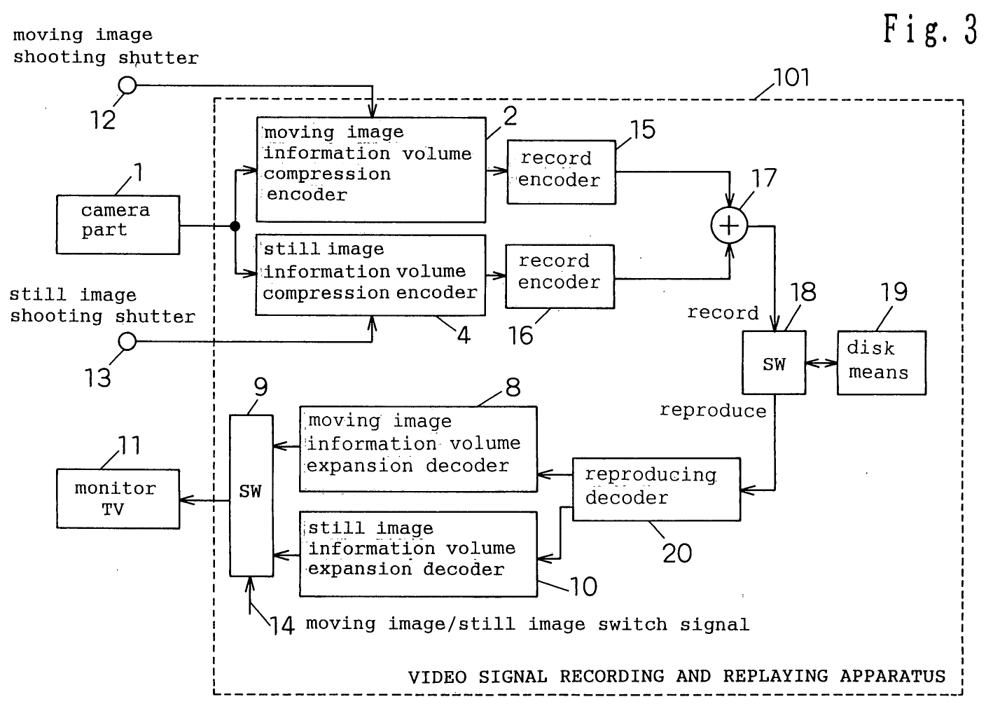

Another example of the structure according to this embodiment will now be described with reference to FIG. 3.

FIG. 3 is a block diagram of the video signal recording and reproducing apparatus in which disk means 19 is used as a recording medium instead of the memory means 6.

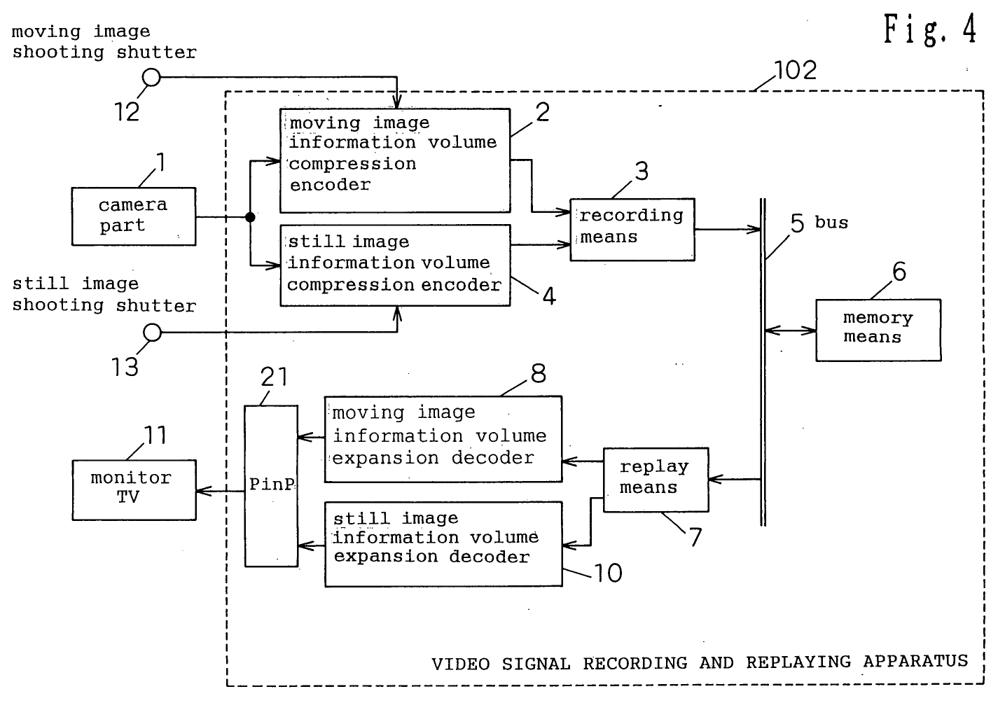

In the video signal recording and reproducing apparatus 102, the recording means 3, the bus 5, the memory means 6 and the reproducing means 7 shown in FIG. 1 are replaced with record encoders 15 and 16, a data volume adder 17, a switch (SW) 18, the disk means 19 and reproducing decoder 20 which are shown in FIG. 4. A difference will now be described.

An error correcting code is added to an output from the moving image information volume compression encoder 2 by the record encoder 15, the output is converted into a record signal string S1 which is suitable to the recording medium, and then added to the data volume adder 17. Meanwhile, an error correcting code is added to an output from the still image information volume compression encoder 4 by the record encoder 16, the output is converted into a record signal string which is suitable to the recording medium, and then added to the data volume adder 17. The record signal strings from the data volume adder 17 are recorded in the disk means 19 via the switch 18.

The disk means 19 referred to here is an optical disk, a magneto-optic disk or a magnetic disk. Data to be recorded are recorded in a file format, as in the case of recording in a memory. In the case of an optical disk or a magneto-optic disk, recording and reproducing may be realized using UDF (Universal Disk Format) or the like. Further, a file in which a moving or still image to be recorded also contains additional information which denotes relevancy and additional information which is related to a time.

During reproduction, a file having a selected moving or still image is fed to the reproducing decoder 20 via the switch 18, and decoded into a moving or still image compression signal. Thus decoded compression signals are respectively fed to the information volume expansion decoders 8 and 10, and a video signal selected by the switch 9 is outputted to the monitor TV 11.

As described above, even when the recording medium is different, it is possible to record a high-quality still image in accordance with a cameraman s wish in any desired manner while shooting a moving image.

### SECOND EMBODIMENT

FIG. 4 is a block diagram which shows a structure of a video signal recording and reproducing apparatus according to a second embodiment of the present invention.

According to the second embodiment, the switch 9 of the video signal recording and reproducing apparatus 100 is replaced with a PinP circuit (picture-in-picture circuit) 21 as in the video signal recording and reproducing apparatus 102 which is shown in FIG. 4.

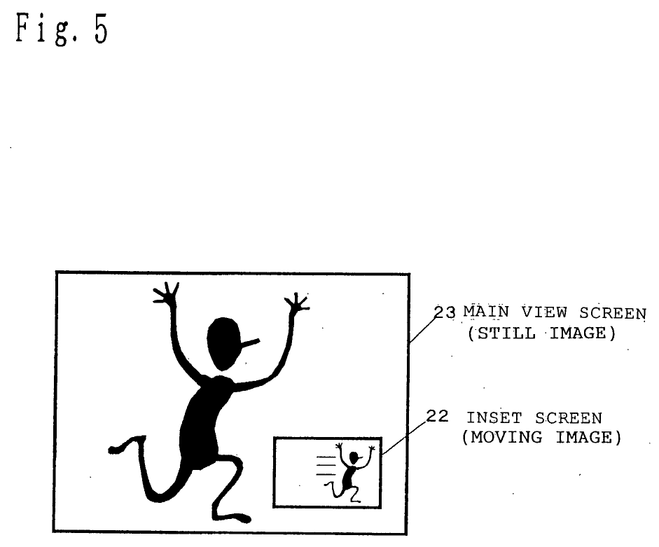

As shown in FIG. 5, it is possible to show both a moving image 22 and a still image 23 at the same time on the screen of the monitor TV 11, according to the second embodiment. The moving image 22 appears within an inset screen, and the still image 23 appears within a main view screen.

Additional information which associates a moving image file to a still image file may be added to the both or either one in the recording means 3. Further, time information at which a still image was generated may be made common to a time stamp, a presentation time or the like to be recorded in a moving image file.

When time information which serves as additional information which associates a moving image to a still image is added at least to a still image file, it is possible to reproduce the shooting timing which is shown in FIG. 2 for example during reproduction.

In this embodiment, as described above, the moving image 22 is reproduced in the inset screen and the still image 23 is reproduced in the main view screen. At this stage, the still image file (signal strings S21 through S24) relevant to the moving image file (signal string S1) is made selectable in advance. As the still image 23 is shown within the main view screen for a predetermined period at such time that the time information represented by the time stamp coincides with the time information added to the still image signal while referring to a time stamp in the moving image file, the timing during shooting is reproduced.

As for the predetermined period referred to here, an immediately precedent still image signal may be displayed until reproduction of the next still image signal starts or may disappear prior to the start of the reproduction.

In other words, the additional information described above associates a moving image to a still image based on the time at which the images were shot, and is added at least to a still image compression signal from the still image information volume compression encoder 4. Meanwhile, the reproducing means 7 specifies the still image compression signal above which is to be reproduced based on the time stamp information contained in a moving image compression signal from the moving image information volume compression encoder 2 and the additional information described above, and determines the timing of starting reproduction of the specified compression signal.

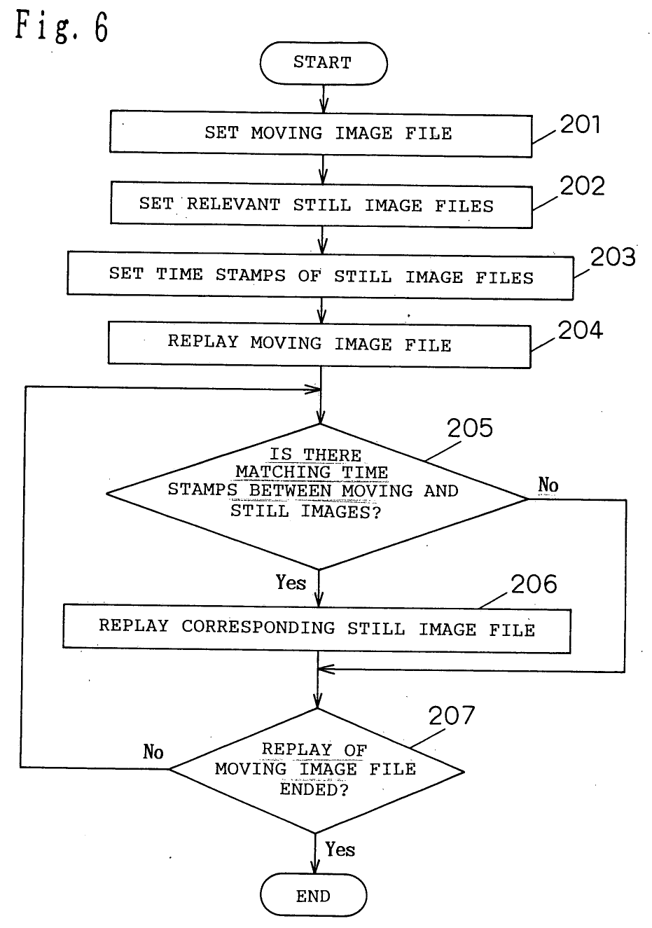

An operation of the structure above will now be described in detail with reference to a flow chart in FIG. 6.

In FIG. 6, at a step 201, a moving image file to be reproduced (S1) is set from the memory means 6.

Next, at a step 202, relevant still image files (S21 to S24) are set from additional information of the moving image file.

At a step 203, time stamps of the still image files are set.

At a step 204, the moving image file set at the step 201 is reproduced.

At a step 205, a time stamp of the moving image file is compared with the time stamps of the still image files set at the step 203, and when there is a match, the sequence proceeds to a step 206.

At the step 206, the corresponding one among the still image files thus set at the step 202 is reproduced.

At a step 207, the end of the reproduction of the moving image file which is being reproduced is monitored, and when the reproduction is to be continued, the sequence returns to the step 205.

Execution of these steps realizes reproduction while reproducing the timing at which the moving image and the still image were short.

According to the embodiment described above, as shown in FIG. 2, the still image file S21 starts to be displayed on the monitor TV 11 at the time t1 and is switched to the still image file S22 at the time t2. However, the present invention is not limited to the above described embodiments, and it is allowed that, for example, another control may be performed so that at timing which corresponds to the time information t0 (See FIG. 2.) and at which reproduction of the moving image file started, the still image file S21 is reproduced and at the timing of t1 it is switched to the still image file S22.

In other words, in this structure, the timing at which the reproducing means 7 starts reproducing a still image file is determined so that this timing practically coincides with the timing (the time t0) at which the monitor TV 11 starts displaying the moving image file S1 decoded by the moving image information volume expansion decoder 8. Further, the timing of the start of displaying of the still image file S22 which was shot at the timing of t2 following the shooting time of the still image file S21 which started to be displayed on the monitor TV 11 substantially coincides with the timing which corresponds to the shooting time t1 of the still image file S21 which has been displayed on the monitor TV 11 until just before the timing of the start of displaying of the still image file S22.

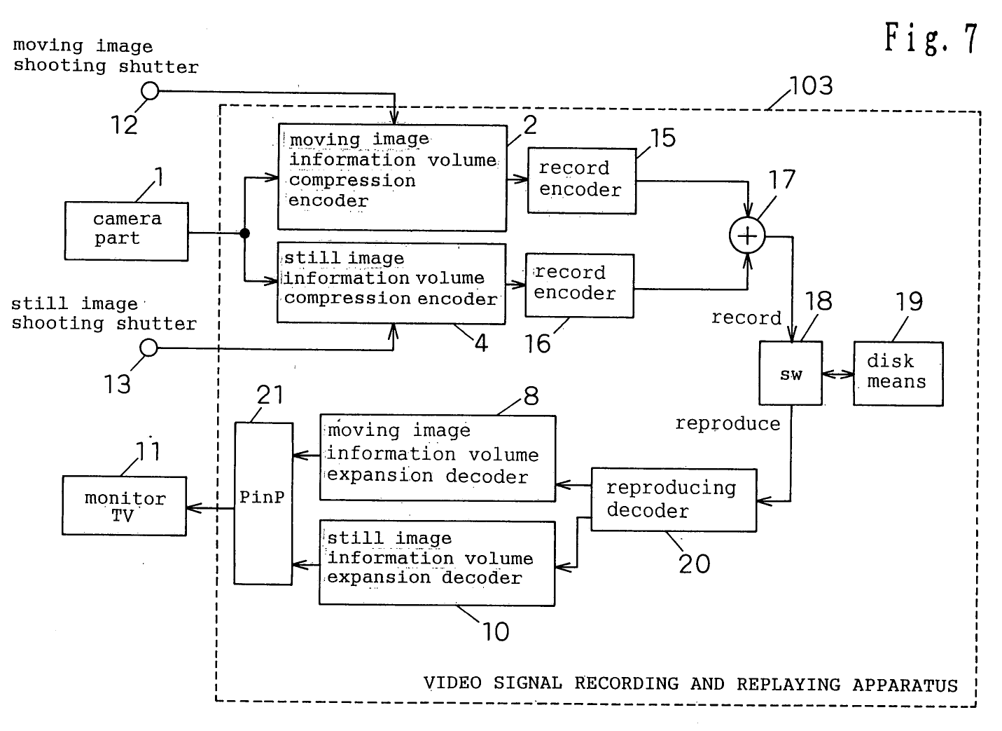

Another example of the structure according to this embodiment will now be described with reference to FIG. 7. A video signal recording and reproducing apparatus 103 shown in FIG. 7 has such a structure which makes the video signal recording and reproducing apparatus 102 shown in FIG. 4 compatible with the disk means 19. The details are the same as those given with reference to FIG. 3, and therefore, will not be described again. The present invention can be thus implemented regardless of the type of a recording medium.

Although the foregoing has described that the moving image information volume compression encoder uses MPEG4, this is not limiting: The moving image information volume compression encoder may use other compression methods such as MPEG2.

Further, although the foregoing has described that the still image information volume compression encoder uses JPEG, this is not limiting: The still image information volume compression encoder may use other compression methods such as JPEG2000 or use a non-compression type.

Further, although the embodiments above have been described in relation to an example of shooting a still image while shooting a moving image, it is needless to mention that the embodiments may be used as a machine which is only for shooting a moving image or only a still image in a similar manner to that a conventional machine is used.

Further, although the embodiments above have been described as a structure which has both a function of recording a video signal and a reproducing function, this is not limiting: For instance, the structure may have only a reproducing function.

That is, such a reproduction-only video signal processing apparatus comprises: (a) reproducing means (which is the reproducing means 7 shown in FIG. 4 for example) which reproduces a signal recorded as a first compression signal obtained by compression-encoding a video signal as a moving image and a signal recorded as a second compression signal obtained by compression-encoding said video signal as a still image; (b) first expansion decoder means (which is the moving image information volume expansion decoder 8 for example) which expands said first compression signals among thus reproduced signals and outputs as a first expansion signal; (c) second expansion decoder means (which is the still image information volume expansion decoder 10 for example) which expands said second compression signal among thus reproduced signals and outputs as a second expansion signal; and (d) synthesizing and outputting means (which is the picture-in-picture circuit 21 for example) which synthesizes said first expansion signal and said second expansion signal with each other and outputs the same on the same screen. It is further preferable to record additional information, too, which is for associating said first compression signal to said second compression signal based on a predetermined reference, together with said recorded signals.

Hence, for example, use of the additional information mentioned above makes it possible to reproduce a still image while reproducing a moving image in the same timing at which the still image was shot, thereby realizing effective reproduction.

A schematic structure diagram for such an instance would be basically the same as FIG. 4 except the structure portions concerning shooting/recording functions, such as the camera part 1 and the recording means 3.

Further, although the foregoing has described the embodiments as examples that the video signal processing apparatus of the present invention is a video signal recording and reproducing apparatus, this is not limiting: For instance, the reproducing function may be omitted.

That is, such a video signal processing apparatus comprises: (1) first compression encoder means which compression-encodes an input video signal as a moving image; (2) second compression encoder means which compression-encodes said input video signal as a still image; and (3) recording means which records both a first compression signal obtained by said first compression encoder means and a second compression signal obtained by said second compression encoder means, wherein said first compression encoder means and said second compression encoder means can be controlled independently of each other.

A program according to the present invention is a program which operates in co-operation with a computer and which makes the computer execute the functions of all or some means (or apparatuses, elements, circuits, parts, etc.) of the video signal processing apparatus according to the present invention described above.

Further, a program according to the present invention is a program which operates in co-operation with a computer and which makes the computer execute all or some steps (or processes, operations, functions, etc.) of the video signal processing method according to the present invention described above.

Further, a recording medium according to the present invention is a recording medium which holds such a program which makes a computer execute all or some functions of all or some means of the video signal processing apparatus according to the present invention described above and which can be read on a computer and which operates in co-operation with a computer when read to thereby execute said functions.

Further, a recording medium according to the present invention is a recording medium which holds such a program which makes a computer execute all or some operations at all or some steps of the video signal processing method according to the present invention described above and which can be read on a computer and which operates in co-operation with a computer when read to thereby execute said functions.

“Some means (or apparatuses, elements, circuits, parts, etc.)” according to the present invention and “some steps (or processes, operations, functions, etc.)” according to the present invention described above refer to some means or steps among these plurality of means or steps, or some functions or some operations in one means or at one step.

In one example of use, a program according to the present invention may be recorded in a recording medium which can be read on a computer so that the program operates in co-operation with the computer.

In one example of use, a program according to the present invention may be transmitted through a transmission medium and read by a computer so that the program operates in co-operation with the computer.

A data structure according to the present invention includes a database, a data format, a data table, a data list, a data type, etc.

The recording medium includes a ROM, etc., whereas the transmission medium includes a transmission medium such as the Internet, light, an electric wave, a sound wave, etc.

As described above, a computer referred to in the present invention is not limited pure hardware such as a CPU but may include firmware, OS, and further, peripheral machines.

As described above, the structure according to the present invention may be realized by software or hardware.

Possibility of Industrial Use

As described above, owing to the two information volume compression encoders one for a moving image and the other for a still image, the present invention permits that from a video signal through the camera part, a particular scene is recorded as a still image in accordance with a cameraman's wish while recording a moving image, thus realizing both recording of a moving image and recording of a still image without a waste of a recording time.

Meanwhile, during reproduction according to the present invention, use of additional information which associates a moving image to a still image for instance makes it possible to reproduce a still image while reproducing a moving image in the same timing at which the still image was shot, thereby realizing effective reproduction.

1. A video signal processing apparatus, comprising:
first compression encoder means of compression-encoding an input video signal as a moving image;
second compression encoder means of compression-encoding said input video signal as a still image; and
recording means of recording both a first compression signal obtained by said first compression encoder means and a second compression signal obtained by said second compression encoder means,
wherein said first compression encoder means and said second compression encoder means can be controlled independently of each other, and said recording means records said first compression signal and said second compression signal respectively at an arbitrary timing.

2. The video signal processing apparatus according to claim 1, wherein said recording means also records additional information which associates said first compression signal to said second compression signal based on a predetermined reference.

3. The video signal processing apparatus according to claim 2, comprising:
reproducing means of reproducing said recorded signals;
first expansion decoder means of expanding said first compression signal among said reproduced signals and outputs as a first expansion signal;
second expansion decoder means of expanding said second compression signal among said reproduced signals and outputs as a second expansion signal; and
synthesizing and outputting means of synthesizing said first expansion signal and said second expansion signal with each other and outputs the synthesized signal on a same screen.

4. The video signal processing apparatus according to claim 3, wherein said second compression signal which is to be reproduced is selected or the timing of outputting said second compression signal is determined, based on said additional information.

5. The video signal processing apparatus according to claim 4, wherein said additional information is associations referring to a shooting time and added at least to said second compression signal, and
said reproducing means specifies said-second compression signal which is to be reproduced based on time stamp information contained in said first compression signal and said additional information added to said second compression signal, and determines timing of starting reproduction of said second compression signal.

6. The video signal processing apparatus according to claim 5, wherein the timing of starting reproduction is determined so as to be substantially the same as the timing at which said first compression signal decoded by said first expansion decoder means starts being displayed by display means, and
a timing of a start of displaying of a second compression signal which is shot at the shooting time following a shooing time of a second compression signal which has started to be displayed substantially coincides with the timing which corresponds to a shooting time of a second compression signal which has been displayed until just before the timing of the start of displaying of the second compression signal.

7. A video signal processing method, comprising:
a first compression encoding step of compression-encoding an input video signal as a moving image;
a second compression encoding step of compression-encoding said input video signal as a still image; and
a recording step of recording both a first compression signal obtained at said first compression encoding step and a second compression signal obtained at said second compression encoding step,
wherein the operation at said first compression encoding step and the operation at said second compression encoding step can be controlled independently of each other, and at said recording step, said first compression signal and said second compression signal are recorded respectively at an arbitrary timing.

8. A program which operates in co-operation with a computer and which makes the computer function as (a) first compression encoder means of compression-encoding an input video signal as a moving image, (b) second compression encoder means of compression-encoding said input video signal as a still image, and (c) recording means of recording both a first compression signal obtained by said first compression encoder means and a second compression signal obtained by said second compression encoder means of the video signal processing apparatus according to any one of claims 1 to 6.

9. A program which makes a computer execute (a) a first compression encoding step of compression-encoding an input video signal as a moving image, (b) a second compression encoding step of compression-encoding said input video signal as a still image, and (c) a recording step of recording both a first compression signal obtained at said first compression encoding step and a second compression signal obtained at said second compression encoding step of the video signal processing method according to claim 7.

10. A recording medium which can be processed by a computer and which holds the program according to claim 8 or 9.

11. The video signal processing apparatus according to claim 1, wherein when recording both said first compression signal and said second compression signal, said recording means records at an improved recording bit rate than the recording bit rate which is used during recording of either one compression signal.
